(19) United States
(12) Patent Application Publication
(10) Pub. No.: US 2004/0114571 A1
(43) Pub. Date: Jun. 17, 2004

(54) Information assistance system and method for effectively consulting multiple resources to assist a user to perform a task

(76) Inventors: Timothy A. Timmins, Tigard, OR (US); Corvin F. Swick, White Salmon, WA (US)

Correspondence Address: Alex L. Yip, Kaye Scholer LLP, 425 Park Avenue, New York, NY, 10022, US

(21) Appl. No.: 10/318,847

(22) Filed: Dec. 13, 2002

(51) Int. Cl. H04L 12/66; H04L 12/28

(52) U.S. Cl. 370/352; 370/401

(57) ABSTRACT

The present invention allows a user to access an information assistance service provider for information to perform a task, e.g., purchase of a product. In response, the service provider may consult multiple resources based on the caller's request and criteria which may be systemic or specified in a user profile. The resources used may be those information sources specified in the user profile, public databases, and vendor and enterprise databases that include information related to products, including product information and product pricing, availability, shipping costs and times, product and activity reviews, and business reputation information.

### BACKGROUND OF THE INVENTION

The invention relates generally to an information assistance system and method. More specifically, the invention relates to a system and method for providing an information assistance service including searching multiple databases to assist a user to perform a task, e.g., a purchase of desired goods or service.

Nowadays, people may access Internet websites to visit virtual stores to find out about goods and services, browse merchandise, compare prices, and purchase items, saving themselves time from having to travel to visit actual stores. However, an online shopper when purchasing goods or service still needs to ascertain “what” the right goods or service is for him/her; “how much” it costs; “when” and from “where” it is delivered. Such “what”, “how much”, “when” and “where” are important criteria for conducting a purchase. For example, a shopper for a new refrigerator to replace a broken one may manage to locate a refrigerator of a desired brand and model, and at a right price. Nevertheless, the purchase would not be consummated if the refrigerator cannot be delivered within a short time to prevent the currently refrigerated food from going bad. Similarly, a person who is hungry may ascertain a restaurant which has the right menu and prices. Nevertheless, the person would not eat there if the restaurant is far from the person's current location, which cannot satisfy his/her immediate need.

### SUMMARY OF THE INVENTION

It has been recognized that it takes much research time to consult multiple resources to resolve the aforementioned “what”, “how much”, “when” and “where” criteria to complete a purchase. In addition, the purchase process itself may sometimes be time- and effort-demanding, e.g., buying from an auction website which entails tendering one or more bids for desired goods and closely monitoring the auction process. The present invention overcomes the prior art limitations by conveniently allowing a user to request an information assistance service to assist him/her to accomplish a task at hand, e.g., a purchase of a product. In accordance with the invention, the user may call an information assistance service to request information for performing a task satisfying one or more criteria. A profile record associated with the user may be accessed by the service, which may be identified by the user telephone number, derivable from an automatic number identification (ANI) associated with the call. The profile record may specify certain user criteria concerning the product, e.g., his/her preferred delivery time, manufacturer, country of origin, etc. It may also specify the user favorite goods or service suppliers and/or their information sources, e.g., the uniform resource locators (URLs) of their websites, information telephone numbers, etc. In response to the user request, the information assistance service consults multiple resources, which include those user favorite information sources which are relevant, public databases, vendor and enterprise databases, providing such information as product pricing, availability, shipping costs and delivery times. Still other databases include auction websites, product and activity reviews, and business reputation information. Criteria used to perform the searches in the case of purchasing a product may include price, product models, delivery time, vendor location, product manufacturer, and product reviews.

After conducting the necessary searches, the information assistance service provides the user with a search result, based on which the user may decide on a purchase. The service may further assist the user to consummate the purchase, e.g., order the product for the user and arrange for its delivery. In accordance with an aspect of the invention, the details of the purchase may be used to update the user profile record, and modify the user criteria and favorite information sources therein.

A further aspect of the invention is the ability to use Starback®-type features, which allow a user to connect to a destination terminal (e.g., a called party), thereby disconnecting the user from the information assistance service provider, and yet be able to summon the service provider for further assistance by initiating a predetermined voice command, e.g., by saying “operator,” or predetermined signal by pressing, e.g., the “*” (star) key on a telephonic device.

Advantageously, by relying on the information assistance service to conduct database searches in accordance with the invention, a user can efficiently obtain information to accomplish the task at hand. The information assistance service also keeps track of the user's preferences and prior searches, thus potentially streamlining the database searches. Additional advantages of the invention will be set forth in the description which follows, and in part will be apparent from the description, or may be learned by practice of the invention. The advantages of the invention may be realized and obtained by means of the instrumentalities and combinations particularly pointed out in the appended claims.

### BRIEF DESCRIPTION OF THE DRAWINGS

The accompanying drawings, in which like reference numerals represent like parts, are incorporated in and constitute a part of the specification. The drawings illustrate presently preferred embodiments of the invention and, together with the general description given above and the detailed description given below, serve to explain the principles of the invention.

FIG. 1 illustrates an arrangement whereby a user accesses an information/call center in accordance with the invention;

FIG. 2 illustrates the information/call center for providing an information assistance service in accordance with the invention;

FIG. 3 illustrates a profile associated with a user of the information assistance service;

FIG. 4 illustrates an arrangement for accessing the profile; and

FIG. 5 is a flowchart depicting a routine for assisting a user to perform a task, including searching multiple information sources in accordance with an embodiment of the present invention.

### DETAILED DESCRIPTION

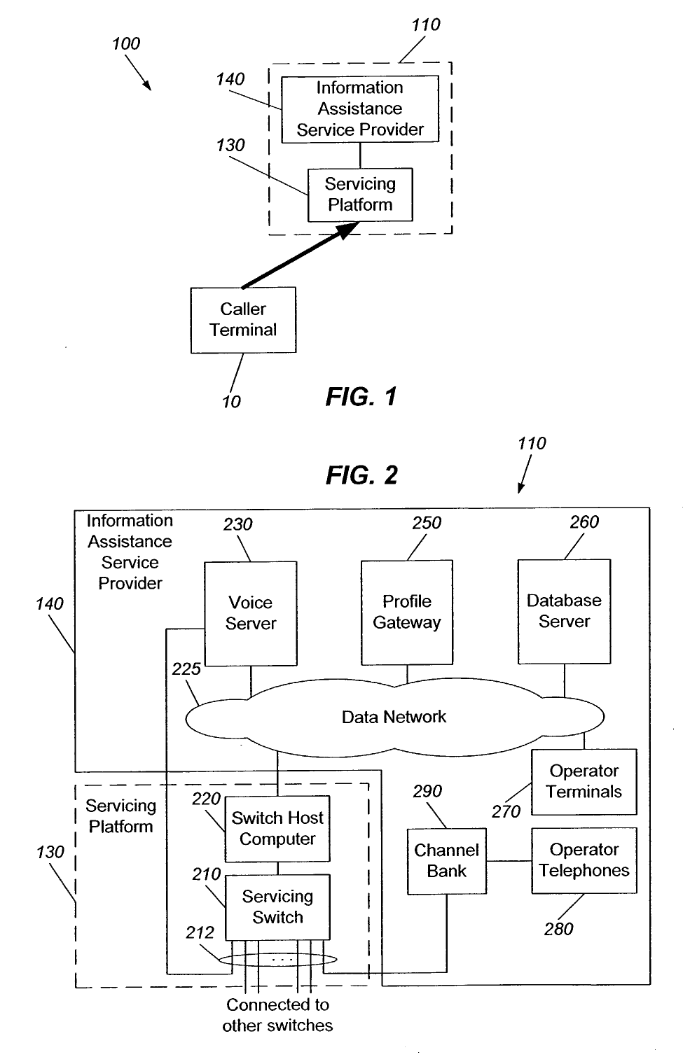

FIG. 1 illustrates arrangement 100 in which a caller initiates an information assistance call from caller terminal 10, which is routed to, say, information/call center 110 via one or more carrier switches in a carrier network, e.g., a public switched telephone network (PSTN), a wireless telephone network, etc. Caller terminal 10 may comprise a wireless telephone, wireline telephone, personal digital assistant (PDA), computer, or other communication device. In a typical directory assistance call, a caller identifies to the operator the name and address (sometimes city or area code) of a party whose telephone number is desired. In response, the operator locates the desired destination telephone number using, e.g., a computer database. The destination number is then provided to the caller, e.g., by a computerized voice server which provides automated voicing of the number, and the caller is afforded an option to be connected to the destination number without the need of first terminating the directory assistance call.

In addition to connecting a caller to a destination number, an operator can provide concierge-type services such as a restaurant guide and reservation service, event ticketing and reservation service, hotel reservation and availability service, travel or flight reservation and ticketing services, ordering specific items such as flowers or food delivery, arranging transportation, and accessing entertainment guides. The use of information assistance to provide such concierge-type services is disclosed, e.g., in copending, commonly-assigned application Ser. No. 09/520,306, “Technique for Providing Information Assistance Including Concierge-Type Services,” filed Mar. 7, 2000, which is incorporated herein by reference. The term “operator” used herein broadly encompasses entities that are capable of providing information assistance in a telecommunications environment, including, without limitation, human operators, voice response/recognition capabilities, web-/WAP-enabled operator services, and other automated and electronic access.

In addition, a caller who subscribes to an information assistance service may have one or more user profiles on file with the service that includes information pertaining to and about the caller, including his/her preferences. Such preferences may specify use of a special skilled operator to answer the caller's call, and include such personal information as favorite restaurants, movies, sporting events, or hobbies. The preferences may also define options of various assistance service features including those described above, e.g., a concierge-type service feature for making restaurant reservations, purchasing tickets, etc.; a second service feature for providing the user with a listing number at anytime during the call; and a third service feature for providing the user with directions to a listing address. Similarly, for example, the methods of delivery (e.g., e-mail, paging, short message service (SMS), etc.) of (i) a confirmation of a reservation or purchase, (ii) a listing number, and (iii) directions to the user may be specified in the user profile as well. The user profile(s) in this instance is maintained in association with, and is identifiable by, among other means, the caller's telephone number.

Referring also to FIG. 2 which illustrates information/call center 110, center 110 may be configured to include information assistance service provider 140 and servicing platform 130. It should be noted that even though both provider 140 and servicing platform 130 appear in the same figure, they may or may not be located in the same geographic area. Servicing platform 130 includes servicing switch 210 having T1 spans 212 or connections by other means for connection to one or more voice servers 230 (although only one is shown in the figure), channel bank 290, and one or more carrier networks. In an alternative embodiment, voice information may be packetized and transmitted pursuant to a voice over Internet Protocol (VoIP) protocol over a packet-switched network, e.g., the Internet, to information/call center 110. Servicing switch 210 may receive an incoming information assistance call from a carrier switch in a carrier network. Servicing switch 210 may also be used to place an outgoing call onto a carrier network, which may be different from the carrier network used for the incoming call.

Channel bank 290 in service provider 140 is used to couple multiple operator telephones 280 to servicing switch 210. The operators in information/call center 110 are further equipped with operator terminals 270, each of which includes a video display unit and a keyboard with an associated dialing pad. Operator terminals 270 are connected over data network 225 to one or more database servers 260 (although only one is shown in the figure). Operators may use database server 260 to provide information assistance including searching various databases in a manner described below to satisfy a caller's request. Switch host computer 220 and voice server 230 are also connected to data network 225. By way of example, data network 225, say, includes at least one local area network (LAN) supplemented by a number of point-to-point data links. Through data network 225 and routers (not shown), components of information/call center 110 may also be connected to the Internet or other wide area networks (WANs).

Servicing switch 210 is conventional and supports digital T1 or perhaps other connectivity. The operation of servicing switch 210 is governed by instructions stored in switch host computer 220. In this illustrative embodiment, servicing switch 210 includes, among other things, arrays of digital signal processors (DSPs). These DSPs can be programmed and reprogrammed to function as, among other things, call progress analyzers (CPAs), call progress generators (CPGs), multi-frequency (MF) tone generators/detectors, voice recognizers, dual-tone multi-frequency (DTMF) generators/detectors, or conference units, depending on the demand placed on information/call center 110 and servicing switch 210 for each corresponding function.

An incoming call requesting information assistance or assistance with searching databases is received by servicing switch 210 in information/call center 110, which connects it to an available operator's telephone. If no operator is available when a call is received, the call is queued in a conventional manner until an operator becomes available. In this instance, automatic call distribution (ACD) logic of conventional design (not shown) is used to queue and distribute calls to operators in the order in which they are received, and such that the call traffic is distributed evenly among the operators. The ACD logic may reside in host computer 220 or in information/call center 110 or elsewhere outside center 110. In other instances, other distribution logic may be utilized, such as skills-based routing or a priority scheme for preferred users.

Voice server 230 (also known as a “voice response unit” or “VRU”) is used to play the constant repeated parts of an operator's speech, namely, the various greetings and signoffs (or closings) as well as other information portions of a call. Voice server 230 is connected via data network 225 to switch host computer 220 and via one or more T1 spans 212 to servicing switch 210. Voice server 230 may comprise a general-purpose computer and one or more voice cards for voice recognition, voice recording and playback, and call progress analysis. At appropriate stages in a call progression, switch host computer 220 initiates a voice path connection between voice server 230 and servicing switch 210 such that the user, or the user and the operator, are able to hear whatever pre-recorded speech is played on that connection by voice server 230. Computer 220 then instructs voice server 230, via data network 225, what type of message to play, and passes data parameters that enable voice server 230 to locate the message appropriate to the call state.

Data network 225 may further connect to one or more profile gateways 250 (although only one is shown in the figure). Profile gateway 250 provides access to a user profile associated with the user, which may include personal information and the user's preferences.

The present invention is directed to providing an information assistance service to a caller who needs to consult different resources to perform a task, e.g., a purchase of goods or service. People may access Internet websites to visit virtual stores to find out about goods and services, browse merchandise, compare prices, and purchase items, saving themselves time from having to travel to visit actual stores. However, an online shopper still needs to ascertain “what” the right goods or service is for him/her; “how much” it costs; “when” and from “where” it is delivered. Such “what”, “how much”, “when” and “where” are important criteria for conducting a purchase, and it takes much time to consult multiple resources to resolve such criteria before the purchase can be consummated.

The invention overcomes the prior art limitations by providing a user with search results satisfying the aforementioned criteria through an information assistance service. In accordance with the invention, upon a user request an information assistance provider, e.g., an operator, searches multiple information sources for information to assist the user to accomplish a task, e.g., a purchase of goods or service in this instance. These information sources may include, e.g., public databases such as Internet websites, certain vendor and enterprise databases to which service provider 140 has direct access through its private network (e.g. WAN), and favorable information sources listed in the aforementioned user profile.

In this illustrative embodiment, users, including users of a particular telephone carrier, may dial, speak or otherwise communicate predetermined access digits, access codes or retail numbers, or input a predetermined address or URL (uniform resource locator) established by the carrier to access information/call center 110. For example, the predetermined access digits may be “411,” “*555,” “555-1212,” “00,” etc. On learning one such access digit sequence initiated from a caller's communications device, a switching system of the caller's telephone carrier in a conventional manner routes the information assistance call to information assistance service provider 140 through a carrier network. In this instance, the carrier network switches the call to servicing platform 130, which is associated with service provider 140.

In this illustrative embodiment, the caller informs an operator who answers the call that he/she desires to purchase a particular product, e.g., TV set. Service provider 140 has access to multiple databases, including the aforementioned public databases, vendor and enterprise databases, and resources favored by the caller specified in a user profile. Such a user profile may also specify preferred vendors, manufacturers, country of origin, shopping criteria (e.g., price, availability, time for delivery, quality, reputation of vendor, consumer reviews (including consumer magazine recommendations), etc.), and weighting of the various criteria.

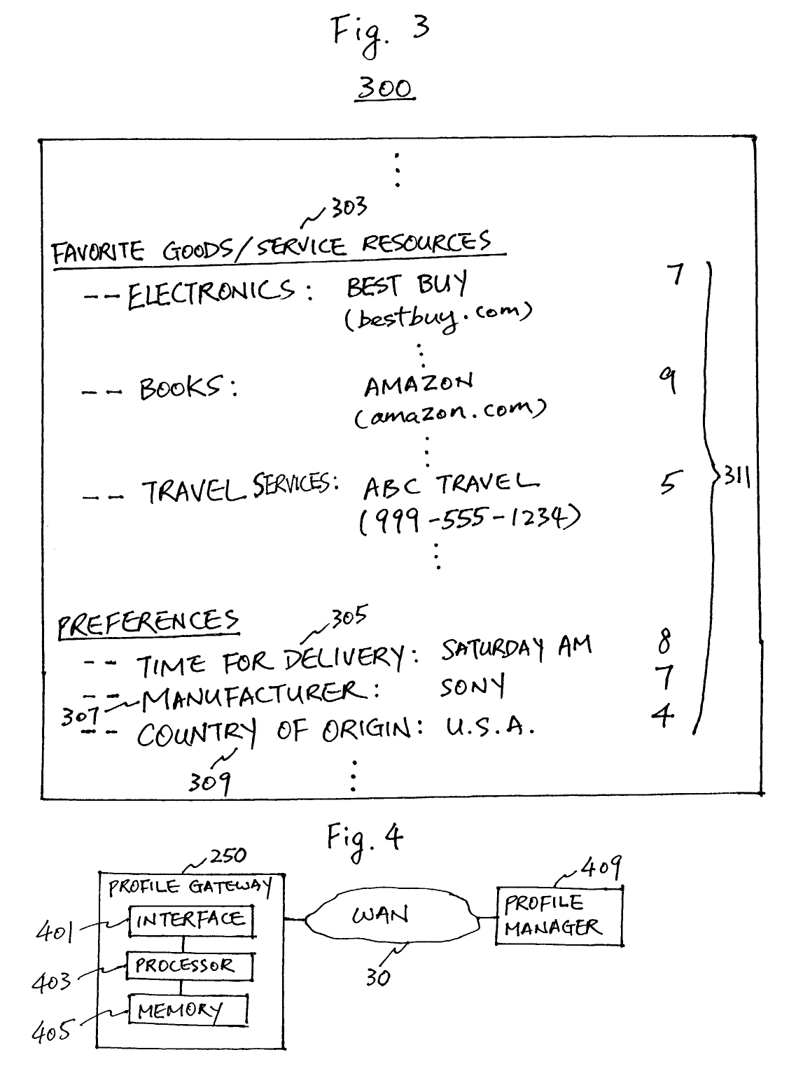

FIG. 3 illustrates user profile 300 associated with the caller. As shown in FIG. 3, profile 300 lists the caller's favorite goods/services resources 303, e.g., Best Buy (bestbuy.com) for electronics, Amazon (amazon.com) for books, ABC travel (999-555-1234) for travel services, etc. In addition, other caller preferences are specified in profile 300, e.g., preferred time for delivery 305 (Saturday morning), preferred manufacturer 307 (Sony), preferred country of origin 309 (U.S.A.), etc. Weighting 311 of each favorite resource and preference is also specified in profile 300 to indicate a measure of the significance of the favorite resource and preference to the caller. The more significant it is to the caller, the larger the weight value, where in this instance 10 is the largest weight value on a scale from 1 to 10. The entries of profile 300 may be established in the initial information assistance service registration by the user in response to such direct questions as “What is your favorite electronics store?” The answers to such direct questions may make up the profile entries. Such profile entries may be subsequently modified from time to time by the caller on his own or, e.g., through the help of an operator. In accordance with another aspect of the invention, entries of profile 300 may evolve over time tracking the caller's behavioral trends, e.g., the caller's buying habit. For instance, if in eight out of the last ten times the caller chose to purchase electronics from Sears through the subject information assistance service, profile 300 may be modified to reflect such a buying habit. As a result, Best Buy may be replaced by Sears as the caller's favorite electronics store in profile 300, or Sears may be added to the favorite electronics store list in profile 300 with a significant weight associated therewith and/or the weight of Best Buy may be reduced. In addition, for example, if 85% of systemwide purchases (exceeding a predetermined threshold), reflecting buying habits of other users/callers, are from Circuit City, user profile 300 may be modified to incorporate such a general buying habit with appropriate weighting, e.g., including Circuit City as one of favorite goods/service resources 303 with a weight smaller than that associated with the caller's personal favorite electronics store.

When the information assistance call is received by servicing platform 130 in FIG. 2, the latter in a well known manner derives, from the signaling associated with the call, the caller's telephone number from which the call originates, also known as an ANI (automatic number identification). Switch host computer 220 then requests any user profile identified by such an ANI from gateway 250 connected to data network 225. Referring also to FIG. 4, gateway 250 receives the profile request including the ANI from data network 225 through interface 401. In response to such a request, processor 403 searches memory 405 for any profile identified by the ANI. It should be noted at this point that all profile data is input and updated through profile manager 305. Copies of the profiles are distributed by manager 409 to the profile gateways in various information/call centers through WAN 30. In this illustrative embodiment, a master copy of the profiles is kept at manager 409. For example, profile gateway 250 initially forwards requests for new profiles to manager 409, and caches copies of the requested profiles from manager 409 in local memory 405 for rapid, subsequent retrieval of the profiles. Memory 405 here generically includes disks, caches, and volatile and nonvolatile memories. When a particular profile in gateway 250 is updated at manager 409, the latter notifies gateway 250 that the particular profile record has expired.

Thus, if processor 403 determines that the requested profile cannot be found in memory 405 or the requested profile has expired, processor 403 forwards the profile request to manager 409 through interface 401. In response, manager 409 provides to gateway 250 any latest profile identified by the ANI or other means. Otherwise, processor 403 retrieves from memory 405 any available, unexpired profile identified by the ANI or other means.

Before the operator answers the call, computer 220 communicates to components in information assistance service provider 140 and, in particular, the operator through terminal 270 any profile data pertinent to the handling of the call. In this instance, the caller requests the operator's assistance to purchase a TV set. In response, the operator brings up on terminal 270 a template to collect the query data used in searching various databases. The user profile data, such as the caller's home and work addresses and phone numbers, e-mail address, etc., may populate the template automatically, thereby obviating the need for interrogation and transcription by the operator. In addition, the operator may obtain from the caller's personal preferences specified in profile 300 described before, e.g., preferred stores, delivery times, and the weighting of the different criteria. Other criteria may be elicited from the caller during the call. For example, the caller in this instance may inform the operator that he/she wants to purchase a 32-inch TV for less than about $600 for delivery within two days.

In response, the operator searches caller's profile 300 for preferred shopping criteria, including preferred electronics store (e.g., Best Buy), manufacturer (e.g., Sony), product review sources (e.g., Consumer Reports Magazine), and criteria weighting (e.g., price most important, then manufacturer, then consumer reviews, etc.). Once the criteria and appropriate weighting are collected, a query is formulated including all of these criteria and the weighting, and various resources, e.g., bestbuy.com specified in the caller's profile 300, public databases, and vendor and enterprise databases, are searched for the appropriate information. The query formulation and the response to the query may be generated by database server 260 capable of searching various databases and websites for appropriate information. In some instances, the operator may call vendors directly for information and enter the received information onto server 260. Server 260 may use heuristic rules to weight the criteria appropriately. For the item in the above example (32-inch TV, less than $600, for delivery within two days), the responses may be as follows, listed in the preferred order according to the criteria weights:

| Choice | | | | | | |
|---|---|---|---|---|---|---|
| # | Manufacturer | Model | Price | Delivery | Retailer | Review |
| 1 | Sony | WEGA | $598 | 2 days | Best Buy | Good |
| 2 | Phillips | Flat Screen | $548 | 3 days | Sears | Very Good |
| 3 | Sylvania | Ultra 32 | $512 | 2 days | Bob's Electronics | Good |
| 4 | Sony | Trinitron | $535 | 3 days | Al's Electronics | Very Good |

The price of each listed item may reflect any price break or discount. Another aspect of the invention includes granting the caller a discount, e.g., a coupon, which may be offered only to users of the information assistance service, or notifying the caller of upcoming sales (possibly, also, only for customers of the information assistance service). For a description of the technique used by an information assistance service for providing promotional information to a user, one may refer, e.g., to copending, commonly assigned application Ser. No. ______, entitled “Technique for Effectively Promoting Goods or Service through an Information Assistance Service,” which is hereby incorporated by reference.

Once a set of search results is returned, the operator informs the caller of the choices and the caller may accept one of the choices or may choose to refine the search. Such refinements may include choosing exact criteria (e.g., TV model must be a Sony WEGA 32-inch) or excluding certain criteria (e.g., delivery must be within two days, exclude Sylvania, exclude Bob's Electronics). A refined search may also include queries from a business reputation database, such as that operated by the Better Business Bureau, to find out about the business reputation of the manufacturer or retailer.

In the above example, if the refinement is to choose the exact TV model, a refined query response may look like this:

| Choice | Manu- | | | | | |
|---|---|---|---|---|---|---|
| # | facturer | Model | Price | Delivery | Retailer | Review |
| 1 | Sony | WEGA | $598 | 2 days | Sears | Good |
| 2 | Sony | WEGA | $625 | 1 day | Macy's | Good |
| 3 | Sony | WEGA | $555 | 3 days | Bob's | Good |
| | | | | | Electronics | |
| 4 | Sony | WEGA | $588 | 2 days | Al's | Good |
| | | | | | Electronics | |

Several other options are available. For instance, once a choice is made, an auction website or system is automatically accessed to check for the same item at a lower price. In such a case, the operator can access that auction site (or system), enter the model desired, search auctions for that model, and enter a bid price that is lower than the price generated through the prior search.

Shipping options and costs may also be factored in. For instance, standard delivery may be three days for $25.00, but quicker delivery (two days) may be an extra $50, and expedited delivery (one day) may be an extra $100. Or, the caller may want to pick up the item rather than having it shipped. Another criterion may thus be the location of the store selling the item. The caller may tell the operator his or her address, or the operator may determine the caller's address by the ANI, by searching a directory database, or by the caller's profile. Then, the operator may determine the distance from the caller to the store selling the item. If the need for the item is immediate, the operator may also access a database with traffic information to determine which location is the quickest to reach. In such a case, once the caller chooses which item to purchase, the operator can request electronically (and receive a confirmation) that the item be held for the caller for pick up.

Thus, in this illustrative embodiment, the databases searched by information assistance service provider 140 may include the caller's user profile and favorite resources specified therein, Internet websites, and vendor and enterprise databases furnished by price comparison services, manufacturers, retailers, consumer review publications, delivery services, and auction providers, as well as databases and websites offering traffic information, telephone and address information (such as a public directory database), and business reputation information. The database search(es) may be expanded or refined based on one or more conditions being present, e.g., the caller's immediate needs.

In accordance with another aspect of the invention, the information concerning the above purchase is fed back to profile manager 409, which records statistical data describing the caller's behavioral trends, e.g., the buying habit in this instance, in the caller's profile. For example, the operator may characterize the purchase as an electronics purchase. The feedback information includes when the electronics purchase was made, from where the electronics was purchased, how much the electronics cost, etc. When manager 409 from time to time updates the statistical data with the feedback information, manager 409 analyzes the recorded statistical data based on a set of predetermined business rules, and accordingly modifies for the caller (and perhaps for others) the relevant part of profile 300 to reflect the caller's buying habit. For instance, if in eight out of the last ten times the caller chose to purchase electronics from Sears through the subject information assistance service, thereby satisfying a predetermined 80% frequency threshold specified by one of the business rules, profile 300 may be modified to reflect such a buying habit. As a result, Best Buy may be replaced by Sears as the caller's favorite electronics store in profile 300, or Sears may be added to the favorite electronics store list in profile 300 with a significant weight associated therewith and/or the weight of Best Buy may be reduced. In addition, manager 409 from time to time performs garbage collection, including deleting outdated statistical data which exceeds a predetermined time limit and any preference whose weight is reduced to zero or close to zero in profile 300.

In a second illustrative embodiment of the invention, the caller may communicate to the operator that he/she wants to undertake an activity on a specific day (e.g., this weekend) with, e.g., his/her spouse and two children, preferably costing less than $100 total. In response, the operator searches the caller's profile, e.g., profile 300, for preferred activity criteria (not shown), including venue (e.g., state park or amusement park or movie), type of activity (e.g., active or passive), reviews (e.g., from the local newspaper), and criteria weighting (e.g., type of activity most important, then cost, then reviews, etc.). Once the criteria and appropriate weighting are collected, a query is formulated including all of these criteria and the weighting and a search is performed of various databases and websites for the appropriate information. As before, the query formulation and the response to the query may be generated by a processor using heuristic rules to weight the criteria appropriately and capable of searching websites and databases for appropriate information, or by the operator him- or herself. For the requested activity in the current example, the responses may be as follows, listed in the preferred order according to the criteria weights: Choice Venue Event Cost Date/Time Distance Review

| Choice | | | | | | |
|---|---|---|---|---|---|---|
| # | Venue | Event | Cost | Date/Time | Distance | Review |
| 1 | State park | Nature walk | $35 | Sat. 3-5 PM | 25 miles | Fair |
| 2 | Amusement park | Rides | $75 | Sat./Sun. all day | 15 miles | Good |
| 3 | Movie | Disney | $40 | Sat./Sun. all day | 4 miles | Very Good |
| 4 | Carnival | Carnival | $60 | Sat./Sun. 11-7 | 10 miles | Very Good |

Once a set of responses is returned, the operator informs the caller of the choices and caller may accept one of the choices or refine the search. Such refinements may include choosing exact criteria (e.g., Disney movie) or excluding certain criteria (e.g., cannot be on Sun. from 1-3 PM, exclude outdoor events). If the refinement in this example is to choose the specific movie, a refined query response may look like this:

| Choice | | | | | | |
|---|---|---|---|---|---|---|
| # | Venue | Event | Cost | Date/Time | Distance | Review |
| 1 | Movie | Disney | $20 | Sat./Sun. 12-3 PM | 6 miles | Very Good |
| 2 | Movie | Disney | $35 | Sat./Sun. all day | 10 miles | Very Good |
| 3 | Movie | Disney | $40 | Sat./Sun. all day | 4 miles | Very Good |
| 4 | Movie | Disney | $40 | Sat./Sun. all day | 10 miles | Very Good |

As with shopping for a TV set, other options may be available. Some activities (such as sporting events or concerts) are available via auctions, and the caller may want to find out if an auction site has tickets for an event at a lower price. As before, the operator can access that auction site, enter the event desired, search auctions for that event, and enter a bid price that is lower than the price generated using the prior search.

Weather and traffic may also be factored in. For instance, by accessing a weather database, the operator determines that a snowstorm is forecast for Saturday afternoon, so it may be desired to not stray too far from home. Or the operator can access traffic information (e.g., via a news station's website) and find out that a parade is scheduled for Sunday at midday, so traffic near the parade might be bad. Armed with the caller's address, which was either told to the operator, retrieved from the caller's personal profile, or searched via a public directory, the operator may determine both the expected weather conditions and the possible street routes to take to get to the event. As with shopping, once the caller chooses which activity to undertake, the operator can request electronically (and receive a confirmation) that the activity has been reserved for them (or, in the case of a movie, concert, or theatre show, tickets have been purchased and will be waiting at the box office to be picked up).

Another aspect of the invention is to undertake a combination of activities. Thus, it may be possible to add a secondary event, e.g., shopping at a mall, to the query, and the Disney movie playing at a mall (or a preferred mall) may be favored over the same movie playing at a location away from a mall or at a less preferred or non-preferred mall, even if the price for the movie is higher at the preferred mall. As with the shopping example above, the invention includes options for granting the caller a price break, a coupon, or notifying the caller of an upcoming sale, and some of these incentives may be offered only to users of the information assistance service.

Thus, in this second illustrative embodiment, the databases searched may include the caller's profile and personal preferences specified therein, Internet websites and private databases offered by governmental institutions (e.g., tourism agencies, parks departments), news agencies (listing activities to do, movie schedules, movie reviews), movie studios (for information about movies), and auction providers, as well as databases and websites offering traffic information, weather information, and telephone and address information (such as a public directory database).

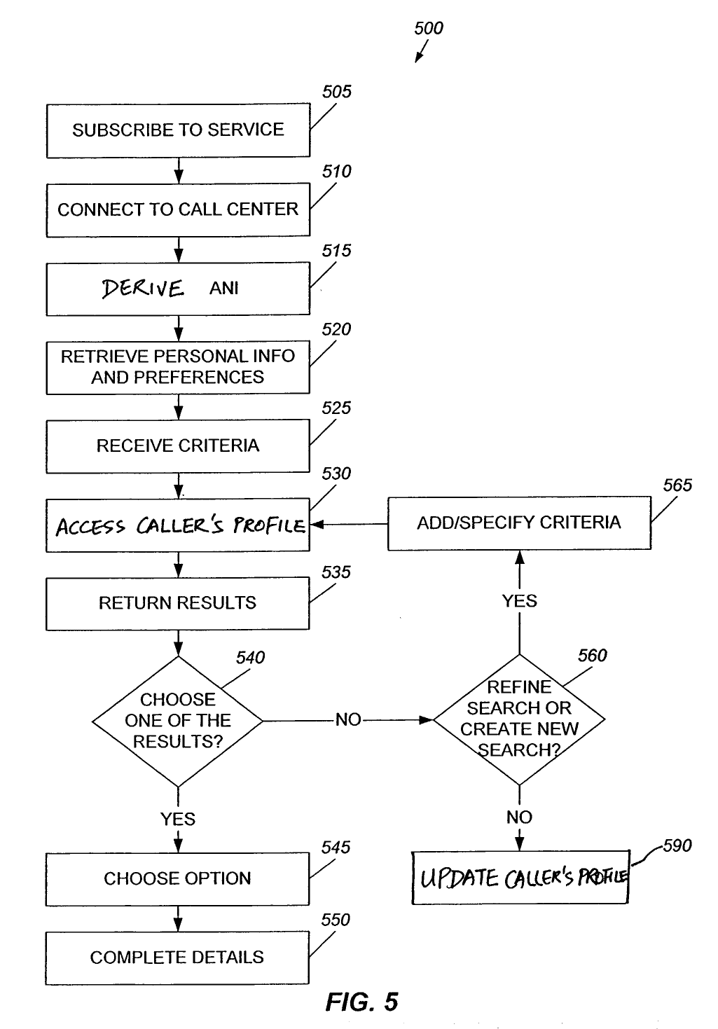

FIG. 5 is a flowchart illustrating routine 500 for consulting multiple resources through an information assistance service in accordance with an embodiment of the present invention. In step 505, a caller initially subscribes to the information assistance service. During this subscription, or at some time later, the caller may set up a user profile including above-described personal preferences for use with the various information services offered by the information/call centers. At the time of subscription, or at any time later, the caller initiates a call from caller terminal 10 by connecting to information/call center 110 as indicated by step 510. In establishing an information assistance call from caller terminal 10, servicing switch 210 receives call set-up signals containing such data as the caller's ANI. In step 515, the ANI information is derived from the call set-up signals. By knowing the caller's ANI, information/call center 110 is able to access the caller's profile 300 as shown in step 520. In step 525, the information assistance service receives criteria for the search to be performed. These criteria may come from the caller's profile 300 and/or they may be elicited from the caller by an operator. The caller makes the request, and the operator fills in as much of a search template as is possible given the criteria specified. Based on the criteria supplied, the information assistance service formulates a query and performs a multiple database search in step 530.

When the search is complete, the information assistance service returns the results to the operator in step 535, in preferential order based on the criteria weights supplied by the caller and/or profile 300. The operator informs the caller of the search results. The operator asks in step 540 if the caller wants to choose one of the results or perform a new or revised search. If the caller is satisfied with the search, the caller chooses one of the results as shown in step 545. In step 550, the operator and caller complete the details of transaction, arranging for payment, delivery, and/or pick-up. If the caller is not satisfied with the search, the operator asks in step 560 whether to refine the search or begin a new search. If the caller does not want to, the caller's profile 300 is updated in step 590 based on the caller's choice in a manner described before. If the caller wants to refine the search or begin a new search, the caller can add criteria or specify new criteria as shown in step 565. Refining the criteria includes, once a specific result is chosen, trying to get a better price, e.g., by entering a bid in an auction website as previously described. Once the criteria for the refined or new search are set, the routine loops back to step 530 to formulate a search query and perform the search. As before, results are returned in step 535, and, after the operator reads the results, the caller can choose one of the results, further refine the search, or perform a new search.

As discussed above, the present invention is illustrated using the purchase of an item and the choosing of an activity, but additional examples, advantages, and modifications will readily occur to those skilled in the art. Therefore, the present invention in its broader aspects is not limited to the specific embodiments, details, and representative devices shown and described herein. Accordingly, various changes, substitutions, and alterations may be made to such embodiments without departing from the spirit or scope of the general inventive concept as defined by the appended claims.

For example, in the illustrative embodiment, profile gateway 250 needs to communicate in real time with profile manager 409 each time when a requested profile is unavailable or expired in memory 405. In an alternative embodiment, to avoid such real time communications with manager 409, thereby saving the response time, a copy of each profile in profile manager 409 is also stored in the profile gateways in all of the information assistance systems, including profile gateway 250. Whenever a change is made to a profile in manager 409, the latter immediately communicates the change to each profile gateway to ensure that each gateway has the current set of profiles, identical to the master set in manager 409. Nonetheless, this “copy-all” approach is disadvantageous in that it requires more local memory capacity to store a larger profile database in each gateway.

In addition, the invention equally applies regardless of whether feature group D (FGD) type signaling, SS7 out-of-band signaling, or other signaling is used for communications between carrier switches and switch 210 of FIG. 2.

Further, the database searching service in accordance with the invention may be provided as a service to a caller who had been connected to a called party through use of an information assistance service, and who then activated Starback® to return to an operator. In a further variation, the caller who had been connected to a called party through use of an information assistance service may invoke further information assistance during the call, as described in co-pending, commonly-assigned application Ser. No. ______, entitled “Technique for Invoking Information Assistance and Services During a Call,” which is incorporated herein by reference. In that variation, either the caller or the called party may summon the operator during a call, the operator is then conferenced in, and, at the request of either party, the operator may then perform a multiple database search based on a request made and criteria enumerated by either the caller or the called party or both.

Finally, information/call center 110 is disclosed herein in a form in which various functions are performed by discrete functional blocks. However, any one or more of these functions could equally well be embodied in an arrangement in which the functions of any one or more of those blocks or, indeed, all of the functions thereof are realized, for example, by one or more appropriately programmed processors.

What is claimed is:

1. A method for providing an information assistance service, comprising:
receiving a call from a caller, the call including a request for information for performing a task satisfying one or more criteria;
accessing a record associated with an identifier of the caller, at least one of the criteria being specified in the record;
in response to the request, searching a plurality of information sources, at least one of the information sources being specified in the record; and
providing the caller with a search result containing the information.

2. The method according to claim 1, further comprising modifying the record using at least part of the information based on which the caller performs the task.

3. The method according to claim 1, wherein the at least one criterion reflects a preference of the caller.

4. The method according to claim 1, wherein one of the information sources is accessed via a communications network.

5. The method according to claim 4, wherein the communications network comprises a wide area network.

6. The method according to claim 4, wherein the communications network comprises at least part of the Internet.

7. The method according to claim 1, wherein the identifier comprises a telephone number associated with the caller.

8. The method according to claim 1, wherein the identifier comprises an automatic number identification (ANI).

9. The method according to claim 1, wherein one of the criteria relates to a time of completion of the task.

10. The method according to claim 1, wherein one of the criteria relates to a location.

11. The method according to claim 1, wherein one of the criteria relates to a cost.

12. The method according to claim 1, wherein the task comprises a purchase of goods or service.

13. The method according to claim 1, wherein the task comprises an activity.

14. The method according to claim 1, wherein the at least one criterion is accorded a weight.

15. The method according to claim 1, wherein the at least one information source is accorded a weight.

16. The method according to claim 1, further comprising detecting any predetermined signal initiated by the caller.

17. The method according to claim 16, further comprising providing additional assistance to the caller after the predetermined signal is detected.

18. A method for assisting a user to perform a task, comprising:
receiving a call from a caller, the call including a request for assistance to perform the task;
accessing a record associated with an identifier of the caller;
in response to the request, searching a plurality of information sources, at least one of the information sources being specified in the record;
providing a search result including a recommendation satisfying the request;
determining whether the caller accepts the recommendation; and
modifying the record based on the recommendation when it is determined that the caller accepts the recommendation.

19. The method according to claim 18, wherein the task is performed under one or more criteria.

20. The method according to claim 19, wherein at least one of the criteria is specified in the record.

21. The method according to claim 20, wherein the at least one criterion reflects a preference of the caller.

22. The method according to claim 20, wherein the at least one criteria is accorded a weight.

23. The method according to claim 19, wherein one of the criteria relates to a time of completion of the task.

24. The method according to claim 19, wherein one of the criteria relates to a location.

25. The method according to claim 19, wherein one of the criteria relates to a cost.

26. The method according to claim 18, wherein at least one of the information sources is accessed via a communications network.

27. The method according to claim 26, wherein the communications network comprises a wide area network.

28. The method according to claim 26, wherein the communications network comprises at least part of the Internet.

29. The method according to claim 18, wherein the identifier comprises a telephone number associated with the caller.

30. The method according to claim 18, wherein the identifier comprises an ANI.

31. The method according to claim 18, wherein the task comprises a purchase of goods or service.

32. The method according to claim 18, wherein the task comprises an activity.

33. The method according to claim 18, wherein the at least one information source is accorded a weight.

34. The method according to claim 18, further comprising detecting any predetermined signal initiated by the caller.

35. The method according to claim 34, further comprising providing additional assistance to the caller after the predetermined signal is detected.

36. A system for providing an information assistance service, comprising:
an interface for receiving a call from a caller, the call including a request for information for performing a task satisfying one or more criteria;
a processor for accessing a record associated with an identifier of the caller, at least one of the criteria being specified in the record; and
a mechanism responsive to the request for searching a plurality of information sources, at least one of the information sources being specified in the record, the caller being provided with a search result containing the information.

37. The system according to claim 36, further comprising a controller for modifying the record using at least part of the information based on which the caller performs the task.

38. The system according to claim 36, wherein the at least one criterion reflects a preference of the caller.

39. The system according to claim 36, wherein one of the information sources is accessed via a communications network.

40. The system according to claim 39, wherein the communications network comprises a wide area network.

41. The system according to claim 39, wherein the communications network comprises at least part of the Internet.

42. The system according to claim 36, wherein the identifier comprises a telephone number associated with the caller.

43. The system according to claim 36, wherein the identifier comprises an ANI.

44. The system according to claim 36, wherein one of the criteria relates to a time of completion of the task.

45. The system according to claim 36, wherein one of the criteria relates to a location.

46. The system according to claim 36, wherein one of the criteria relates to a cost.

47. The system according to claim 36, wherein the task comprises a purchase of goods or service.

48. The system according to claim 36, wherein the task comprises an activity.

49. The system according to claim 36, wherein the at least one criterion is accorded a weight.

50. The system according to claim 36, wherein the at least one information source is accorded a weight.

51. The system according to claim 36, further comprising a signal processor for detecting any predetermined signal initiated by the caller.

52. The system according to claim 51, wherein additional assistance is provided to the caller after the predetermined signal is detected.

53. A system for assisting a user to perform a task, comprising:
an interface for receiving a call from a caller, the call including a request for assistance to perform the task;
a first processor for accessing a record associated with an identifier of the caller;
a mechanism responsive to the request for searching a plurality of information sources, at least one of the information sources being specified in the record, the caller being provided with a search result including a recommendation satisfying the request;
a second processor for determining whether the caller accepts the recommendation; and
a controller for modifying the record based on the recommendation when it is determined that the caller accepts the recommendation.

54. The system according to claim 53, wherein the task is performed under one or more criteria.

55. The system according to claim 54, wherein at least one of the criteria is specified in the record.

56. The system according to claim 55, wherein the at least one criterion reflects a preference of the caller.

57. The system according to claim 55, wherein the at least one criteria is accorded a weight.

58. The system according to claim 54, wherein one of the criteria relates to a time of completion of the task.

59. The system according to claim 54, wherein one of the criteria relates to a location.

60. The system according to claim 54, wherein one of the criteria relates to a cost.

61. The system according to claim 53, wherein at least one of the information sources is accessed via a communications network.

62. The system according to claim 61, wherein the communications network comprises a wide area network.

63. The system according to claim 61, wherein the communications network comprises at least part of the Internet.

64. The system according to claim 53, wherein the identifier comprises a telephone number associated with the caller.

65. The system according to claim 53, wherein the identifier comprises an ANI.

66. The system according to claim 53, wherein the task comprises a purchase of goods or service.

67. The system according to claim 53, wherein the task comprises an activity.

68. The system according to claim 53, wherein the at least one information source is accorded a weight.

69. The system according to claim 53, further comprising a signal processor for detecting any predetermined signal initiated by the caller.

70. The system according to claim 69, wherein additional assistance is provided to the caller after the predetermined signal is detected.
